(19) United States
(12) Patent Application Publication
(10) Pub. No.: US 2015/0150253 A1
(43) Pub. Date: Jun. 4, 2015

(54) CROP ENHANCEMENT COMPOSITIONS

(71) Applicant: Syngenta Participations AG, Basel (CH)

(72) Inventors: Peter Schneiter, Stein (CH); Alfred Rindlisbacher, Stein (CH)

(73) Assignee: SYNGENTA PARTICIPATIONS AG, Basel (CH)

(21) Appl. No.: 14/406,262

(22) PCT Filed: Jun. 11, 2013
(86) PCT No.: PCT/EP2013/060959

§ 371 Date: Dec. 8, 2014

(30) Foreign Application Priority Data
Jun. 11, 2012 (GB) 1210395.8

(51) Int. Cl. A01N 37/28; A01N 43/56; A01N 37/30; A01N 43/78; A01N 43/36; A01N 43/54; A01N 43/653

(52) U.S. Cl. CPC A01N 37/28; A01N 43/54; A01N 43/56; A01N 43/653; A01N 43/78; A01N 43/36; A01N 37/30

(57) ABSTRACT

The invention relates to pesticidal mixtures. In particular, it relates to pesticidal mixtures comprising at least one crop enhancer compound.

The invention relates to pesticidal mixtures. In particular, it relates to pesticidal mixtures comprising at least one crop enhancer compound.

It is known in the art that some compounds can enhance the growth of plants. One such compound is the compound of formula (I):

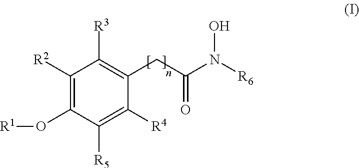

wherein:
R₁ is alkyl or H;
R₂, R₃, R₄ and R₅ are independently selected from the group consisting of H, halide, —NO₂, —SO₂R′, —OH, —Oalkyl where R′ is alkyl or aminoalkyl;
and/or R₁ and R₅ are joined as —O(CH₂)ₘ—, where m is 1, 2, 3 or 4;
R₆ is a substituted or non-substituted alkyl, and/or substituted or non-substituted aryl; and
n is an integer of 1 to 4.

Methods of making such compounds are disclosed in International Publication Number WO2010/055316.

According to the present invention, there is provided a composition comprising (A) a compound of formula (I),

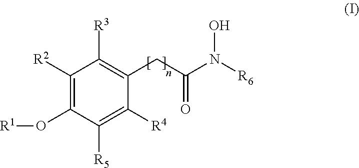

wherein:
R₁ is alkyl or H;
R₂, R₃, R₄ and R₅ are independently selected from the group consisting of H, halide, —NO₂, —SO₂R′, —OH, —Oalkyl where R′ is alkyl or aminoalkyl;
and/or R₁ and R₅ are joined as —O(CH₂)ₘ—, where m is 1, 2, 3 or 4;
R₆ is a substituted or non-substituted alkyl, and/or substituted or non-substituted aryl; and
n is an integer of 1 to 4;
(B) at least one other active ingredient, and optionally (C) one or more formulation adjuvants.

The use of component (B) in combination with component (A) provides a simple solution for the grower to co-apply desired crop enhancing and pesticidal compounds together. The use of component (B) in combination with component (A) may enhance the effectiveness of either component such that it results in an improved crop enhancement effect, an improved pesticidal effect, or both.

An improved crop enhancement effect includes an improvement in plant vigour, an improvement in plant quality, improved tolerance to stress factors, and/or improved input use efficiency. An improved pesticidal effect includes improved control of pests such as insects, fungi, nematodes.

Component (B) may be any known active ingredient, for example as disclosed in the Pesticide Manual (The Pesticide Manual—A World Compendium; Fifteenth edition; Editor: C. D. S. Tomlin; The British Crop Protection Council). In particular, component (B) may be an acaricide, bactericide, fungicide, herbicide, insecticide, molluscicide, nematicide, plant activator, plant growth regulator, rodenticide, safener or synergist.

In general, the weight ratio of component (A) to component (B) is from 2000:1 to 1:1000. The weight ratio of component (A) to component (B) is preferably from 100:1 to 1:100; more preferably from 20:1 to 1:50.

The active ingredient mixture of component (A) to component (B) comprises compounds of formula I and a further active ingredients preferably in a mixing ratio of from 1000:1 to 1:1000, especially from 50:1 to 1:50, more especially in a ratio of from 20:1 to 1:20, even more especially from 10:1 to 1:10, very especially from 5:1 and 1:5, special preference being given to a ratio of from 2:1 to 1:2, and a ratio of from 4:1 to 2:1 being likewise preferred. These mixing ratios are understood to include, both ratios by weight and also molar ratios.

Certain weight ratios of component (A) to component (B) may give rise to synergistic activity. Therefore, according to a further aspect of the invention there is provided a composition, wherein component (A) and component (B) are present in the composition in amounts producing a synergistic effect. This synergistic activity is apparent from the fact that the activity of the composition comprising component (A) and component (B) is greater than the sum of the corresponding activities of component (A) and of component (B) alone. This synergistic activity extends the range of action of component (A) and component (B) in two ways. Firstly, the rates of application of component (A) and component (B) are lowered whilst the action remains equally good, meaning that the active ingredient mixture still achieves a high degree of phytopathogen control even where the two individual components have become totally ineffective in such a low application rate range. Secondly, there is a substantial broadening of the spectrum of phytopathogens that can be controlled.

A synergistic effect exists whenever the action of an active ingredient combination is greater than the sum of the actions of the individual components. The action to be expected E for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):

ppm=milligrams of active ingredient (=a.i.) per liter of spray mixture
X=% action by active ingredient A) using p ppm of active ingredient
Y=% action by active ingredient B) using q ppm of active ingredient.
According to COLBY, the expected (additive) action of active ingredients A)+B) using p+q ppm of active ingredient is

$$E = X + Y - \frac{X \cdot Y}{100}$$

If the action actually observed (O) is greater than the expected action (E), then the action of the combination is super-additive, i.e. there is a synergistic effect. In mathematical terms, synergism corresponds to a positive value for the difference of (O-E). In the case of purely complementary addition of activities (expected activity), said difference (O-E) is zero. A negative value of said difference (O-E) signals a loss of activity compared to the expected activity.

However, besides any synergistic action, the compositions according to the invention can also have further surprising advantageous properties. Examples of such advantageous properties that may be mentioned are: more advantageuos degradability; improved toxicological and/or ecotoxicological behaviour; or improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination.

Some compositions according to the invention have a systemic action and can be used as foliar, soil and seed treatment fungicides.

With the compositions according to the invention it is possible to inhibit or destroy the phytopathogenic microorganisms which occur in plants or in parts of plants (fruit, blossoms, leaves, stems, tubers, roots) in different useful plants, while at the same time the parts of plants which grow later are also protected from attack by phytopathogenic microorganisms.

The compositions according to the invention can be applied to the phytopathogenic microorganisms, the useful plants, the locus thereof, the propagation material thereof, storage goods or technical materials threatened by microorganism attack.

The compositions according to the invention may be applied before or after infection of the useful plants, the propagation material thereof, storage goods or technical materials by the microorganisms.

A further aspect of the present invention is a method of controlling diseases on useful plants or on propagation material thereof caused by phytopathogens, which comprises applying to the useful plants, the locus thereof or propagation material thereof a composition according to the invention.

Preferred is a method, which comprises applying to the useful plants or to the locus thereof a composition according to the invention, more preferably to the useful plants. Further preferred is a method, which comprises applying to the propagation material of the useful plants a composition according to the invention.

Suitably, components (A) and (B) are each applied in amounts effective to achieve the desired effect of each active ingredient.

Where the components (B) are included in The Pesticide Manual they are described therein under the entry number given in round brackets below for the particular component (B); for example, the compound “abamectin” is described under entry number (1).

Examples of component (B) include, but are not limited to, the following:

Acaricides for example 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50′439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-S-methyl (224), demeton-S-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), diflovidazin [CCN], dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfiram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxy-aminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin (II) (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfiram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN], YI-5302 (compound code);
Bactericides for example 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766), thiomersal (alternative name) [CCN];
Fungicides for example:
strobilurin fungicides selected from azoxystrobin (47), dimoxystrobin (226), enestrobin, fluoxastrobin (382), kresoxim-methyl (485), metominostrobin (551), orysastrobin, picoxystrobin (647), pyraclostrobin (690); trifloxystrobin (832);
azole fungicides selected from azaconazole (40), bromuconazole (96), cyproconazole (207), difenoconazole (247), diniconazole (267), diniconazole-M (267), epoxiconazole (298), fenbuconazole (329), fluquinconazole (385), flusilazole (393), flutriafol (397), hexaconazole (435), imazalil (449), imibenconazole (457), ipconazole (468), metconazole (525), myclobutanil (564), oxpoconazole (607), pefurazoate (618), penconazole (619), prochloraz (659), propiconazole (675), prothioconazole (685), simeconazole (731), tebuconazole (761), tetraconazole (778), thiabendazole (790), triadimefon (814), triadimenol (815), triflumizole (834), triticonazole (842), diclobutrazol (1068), etaconazole (1129), furconazole (1198), furconazole-cis (1199) and quinconazole (1378);
morpholine fungicides selected from aldimorph, dodemorph (288), fenpropimorph (344), flumorph, tridemorph (830), fenpropidin (343), spiroxamine (740), and piperalin (648);
anilino-pyrimidine fungicides selected from cyprodinil (208), mepanipyrim (508) and pyrimethanil (705);
fungicides selected from the group consisting of isopyrazam (881685-58-1), sedaxane (874967-67-6), bixafen (581809-46-3), penthiopyrad (183675-82-3), fluxapyroxad (907204-31-3), boscalid (188425-85-6), penflufen (494793-67-8), fluopyram (658066-35-4),
fungicides selected from the group consisting of anilazine (878), arsenates, benalaxyl (56), benalaxyl-M, benodanil (896), benomyl (62), benthiavalicarb, benthiavalicarb-isopropyl (68), biphenyl (81), bitertanol (84), blasticidin-S (85), bordeaux mixture (87), boscalid (88), bupirimate (98), cadmium chloride, captafol (113), captan (114), carbendazim (116), carbon disulfide (945), carboxin (120), carpropamid (122), cedar leaf oil, chinomethionat (126), chlorine, chloroneb (139), chlorothalonil (142), chlozolinate (149), cinnamaldehyde, copper, copper ammoniumcarbonate, copper hydroxide (169), copper octanoate (170), copper oleate, copper sulphate (87), cyazofamid (185), cycloheximide (1022), cymoxanil (200), dichlofluanid (230), dichlone (1052), dichloropropene (233), diclocymet (237), diclomezine (239), dicloran (240), diethofencarb (245), diflumetorim (253), dimethirimol (1082), dimethomorph (263), dinocap (270), dithianon (279), dodine (289), edifenphos (290), ethaboxam (304), ethirimol (1133), etridiazole (321), famoxadone (322), fenamidone (325), fenaminosulf (1144), fenamiphos (326), fenarimol (327), fenfuram (333), fenhexamid (334), fenoxanil (338), fenpiclonil (341), fentin acetate (347), fentin chloride, fentin hydroxide (347), ferbam (350), ferimzone (351), fluazinam (363), fludioxonil (368), flusulfamide (394), flutolanil (396), folpet (400), formaldehyde (404), fosetyl-aluminium (407), fthalide (643), fuberidazole (419), furalaxyl (410), furametpyr (411), flyodin (1205), fuazatine (422), hexachlorobenzene (434), hymexazole, iminoctadine (459), iodocarb (3-Iodo-2-propynyl butyl carbamate), iprobenfos (IBP) (469), iprodione (470), iprovalicarb (471), isoprothiolane (474), kasugamycin (483), mancozeb (496), maneb (497), manganous dimethyldithiocarbamate, mefenoxam (Metalaxyl-M) (517), mepronil (510), mercuric chloride (511), mercury, metalaxyl (516), methasulfocarb (528), metiram (546), metrafenone, nabam (566), neem oil (hydrophobic extract), nuarimol (587), octhilinone (590), ofurace (592), oxadixyl (601), oxine copper (605), oxolinic acid (606), oxycarboxin (608), oxytetracycline (611), paclobutrazole (612), paraffin oil (628), paraformaldehyde, pencycuron (620), penflufen, pentachloronitrobenzene (716), pentachlorophenol (623), penthiopyrad, perfurazoate, phosphoric acid, polyoxin (654), polyoxin D zinc salt (654), potassium bicarbonate, probenazole (658), procymidone (660), propamocarb (668), propineb (676), proquinazid (682), prothiocarb (1361), pyrazophos (693), pyrifenox (703), pyroquilon (710), quinoxyfen (715), quintozene (PCNB) (716), silthiofam (729), sodium bicarbonate, sodium diacetate, sodium propionate, streptomycin (744), sulphur (754), TCMTB, tecloftalam, tecnazene (TCNB) (767), thifluzamide (796), thiophanate (1435), thiophanate-methyl (802), thiram (804), tolclofos-methyl (808), tolylfluanid (810), triazoxide (821), trichoderma harzianum (825), tricyclazole (828), triforine (838), triphenyltin hydroxide (347), validamycin (846), vinclozolin (849), zineb (855), ziram (856), zoxamide (857), 1,1-bis(4-chlorophenyl)-2-ethoxyethanol (IUPAC-Name) (910), 2,4-dichlorophenyl benzenesulfonate (IUPAC-/Chemical Abstracts-Name) (1059), 2-fluoro-N-methyl-N-1-naphthylacetamide (IUPAC-Name) (1295), 4-chlorophenyl phenyl sulfone (IUPAC-Name) (981), mandipropamid, fluopicolide, cyflufenamid, pyribencarb, amisulbrom;
Herbicides for example acetochlor, acifluorfen, acifluorfen-sodium, aclonifen, acrolein, alachlor, alloxydim, allyl alcohol, ametryn, amicarbazone, amidosulfuron, aminocyclopyrachlor, aminopyralid, amitrole, ammonium sulfamate, anilofos, asulam, atraton, atrazine, azimsulfuron, BCPC, beflubutamid, benazolin, bencarbazone, benfluralin, benfuresate, bensulfuron, bensulfuron-methyl, bensulide, bentazone, benzfendizone, benzobicyclon, benzofenap, bicyclopyrone, bifenox, bilanafos, bispyribac, bispyribac-sodium, borax, bromacil, bromobutide, bromoxynil, butachlor, butafenacil, butamifos, butralin, butroxydim, butylate, cacodylic acid, calcium chlorate, cafenstrole, carbetamide, carfentrazone, carfentrazone-ethyl, CDEA, CEPC, chlorflurenol, chlorflurenol-methyl, chloridazon, chlorimuron, chlorimuron-ethyl, chloroacetic acid, chlorotoluron, chlorpropham, chlorsulfuron, chlorthal, chlorthal-dimethyl, cinidon-ethyl, cinmethylin, cinosulfuron, cisanilide, clethodim, clodinafop, clodinafop-propargyl, clomazone, clomeprop, clopyralid, cloransulam, cloransulam-methyl, CMA, 4-CPB, CPMF, 4-CPP, CPPC, cresol, cumyluron, cyanamide, cyanazine, cycloate, cyclosulfamuron, cycloxydim, cyhalofop, cyhalofop-butyl, 2,4-D, 3,4-DA, daimuron, dalapon, dazomet, 2,4-DB, 3,4-DB, 2,4-DEB, desmedipham, dicamba, dichlobenil, ortho-dichlorobenzene, para-dichlorobenzene, dichlorprop, dichlorprop-P, diclofop, diclofop-methyl, diclosulam, difenzoquat, difenzoquat metilsulfate, diflufenican, diflufenzopyr, dimefuron, dimepiperate, dimethachlor, dimethametryn, dimethenamid, dimethenamid-P, dimethipin, dimethylarsinic acid, dinitramine, dinoterb, diphenamid, diquat, diquat dibromide, dithiopyr, diuron, DNOC, 3,4-DP, DSMA, EBEP, endothal, EPTC, esprocarb, ethalfluralin, ethametsulfuron, ethametsulfuron-methyl, ethofumesate, ethoxyfen, ethoxysulfuron, etobenzanid, fenoxaprop-P, fenoxaprop-P-ethyl, fentrazamide, ferrous sulfate, flamprop-M, flazasulfuron, florasulam, fluazifop, fluazifop-butyl, fluazifop-P, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, fluoroglycofen, fluoroglycofen-ethyl, flupropanate, flupyrsulfuron, flupyrsulfuron-methyl-sodium, flurenol, fluridone, flurochloridone, fluroxypyr, flurtamone, fluthiacet, fluthiacet-methyl, fomesafen, foramsulfuron, fosamine, glufosinate, glufosinate-ammonium, glufosinate-P, glyphosate, glyphosate-trimesium, halosulfuron, halosulfuron-methyl, haloxyfop, haloxyfop-P, HC-252, hexazinone, imazamethabenz, imazamethabenz-methyl, imazamox, imazapic, imazapyr, imazaquin, imazethapyr, imazosulfuron, indanofan, indaziflam, iodomethane, iodosulfuron, iodosulfuron-methyl-sodium, ioxynil, ipfencarbazone, isoproturon, isouron, isoxaben, isoxachlortole, isoxaflutole, karbutilate, lactofen, lenacil, linuron, MAA, MAMA, MCPA, MCPA-thioethyl, MCPB, mecoprop, mecoprop-P, mefenacet, mefluidide, mesosulfuron, mesosulfuron-methyl, mesotrione, metam, metamifop, metamitron, metazachlor, methabenzthiazuron, methylarsonic acid, methyldymron, methyl isothiocyanate, metobenzuron, metolachlor, S-metolachlor, metosulam, metoxuron, metribuzin, metsulfuron, metsulfuron-methyl, MK-616, molinate, monolinuron, MSMA, naproanilide, napropamide, naptalam, neburon, nicosulfuron, nonanoic acid, norflurazon, oleic acid (fatty acids), orbencarb, orthosulfamuron, oryzalin, oxadiargyl, oxadiazon, oxasulfuron, oxaziclomefone, oxyfluorfen, paraquat, paraquat dichloride, pebulate, pendimethalin, penoxsulam, pentachlorophenol, pentanochlor, pentoxazone, pethoxamid, petrolium oils, phenmedipham, phenmedipham-ethyl, picloram, picolinafen, pinoxaden, piperophos, potassium arsenite, potassium azide, pretilachlor, primisulfuron, primisulfuron-methyl, prodiamine, profluazol, profoxydim, prometon, prometryn, propachlor, propanil, propaquizafop, propazine, propham, propisochlor, propoxycarbazone, propoxycarbazone-sodium, propyrisulfuron, propyzamide, prosulfocarb, prosulfuron, pyraclonil, pyraflufen, pyraflufen-ethyl, pyrasulfutole, pyrazolynate, pyrazosulfuron, pyrazosulfuron-ethyl, pyrazoxyfen, pyribenzoxim, pyributicarb, pyridafol, pyridate, pyriftalid, pyriminobac, pyriminobac-methyl, pyrimisulfan, pyrithiobac, pyrithiobac-sodium, pyroxsulam, pyroxasulfone, quinclorac, quinmerac, quinoclamine, quizalofop, quizalofop-P, rimsulfuron, saflufenacil, sethoxydim, siduron, simazine, simetryn, SMA, sodium arsenite, sodium azide, sodium chlorate, sulcotrione, sulfentrazone, sulfometuron, sulfometuron-methyl, sulfosate, sulfosulfuron, sulfuric acid, tar oils, 2,3,6-TBA, TCA, TCA-sodium, tebuthiuron, tefuryltrione, tembotrione, tepraloxydim, terbacil, terbumeton, terbuthylazine, terbutryn, thenylchlor, thiazopyr, thiencarbazone, thifensulfuron, thifensulfuron-methyl, thiobencarb, tiocarbazil, topramezone, tralkoxydim, tri-allate, triasulfuron, triaziflam, tribenuron, tribenuron-methyl, tricamba, triclopyr, trietazine, trifloxysulfuron, trifloxysulfuron-sodium, trifluralin, triflusulfuron, triflusulfuron-methyl, trihydroxytriazine, tritosulfuron, [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetic acid ethyl ester (CAS RN 353292-31-6), 4-[(4,5-dihydro-3-methoxy-4-methyl-5-oxo)-1H-1,2,4-triazol-1-ylcarbonylsulfamoyl]-5-methylthiophene-3-carboxylic acid (BAY636), BAY747 (CAS RN 335104-84-2), topramezone (CAS RN 210631-68-8), 4-hydroxy-3-[[2-[(2-methoxyethoxy)methyl]-6-(trifluoromethyl)-3-pyridinyl]carbonyl]-bicyclo[3.2.1]oct-3-en-2-one (CAS RN 352010-68-5), and 4-hydroxy-3-[[2-(3-methoxypropyl)-6-(difluoromethyl)-3-pyridinyl]carbonyl]-bicyclo[3.2.1]oct-3-en-2-one;
Insecticides for example 1,1-dichloro-1-nitroethane (IUPAC/Chemical Abstracts name) (1058), 1,1-dichloro-2,2-bis(4-ethylphenyl)ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichlorophenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxyl)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethylcarbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl) ether (IUPAC name) (909), bistrifluron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyanide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorantraniliprole, chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyantranipilrole, cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-S-methyl (224), demeton-S-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-ylphosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyanide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothio-phosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-ylphosphorothioate (IUPAC name) (1075), 0,0,0′,0′-tetrapropyl dithiopyro-phosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyanide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469), ZXI 8901 (development code) (858);
Molluscicides for example bis(tributyltin) oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347), triphenyltin hydroxide (IUPAC name) (347);
Nematicides for example 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code), zeatin (alternative name) (210);
Plant activators for example acibenzolar (6), acibenzolar-S-methyl (6), probenazole (658), Reynoutria sachalinensis extract (alternative name) (720);
Plant growth regulators for example 1-methylcyclopropene; 1-naphthol; 2,3,5-tri-iodobenzoic acid; 2,3,5-tri-iodobenzoic acid; 2,3-Dihydro-5,6-diphenyl-1,4-oxath(II)ne; 2,4,5-T; 2,4-D; 2,4-DB; 2,4-DEP; 24-epi-brassinolide; 28-homobrassinolide; 2-cyano-3-(2,4-dichlorophenyl)acrylic acid; 2-hydrazinoethanol; 2iP; 4-CPA; 4-hydroxyphenethyl alcohol; abscisic acid, AC 94377, BTS 44584, ACC, ancymidol, aviglycine, bachmedesh, benzofluor, benzyladenine, brassinolide, brassinolide-ethyl, buminafos, butralin, calcium cyanamide, carbaryl, carvone, chlorfluren, chlorflurenol, chlormequat, chlorphonium, chlorpropham, choline chloride, ciobutide, clofencet, clofibric acid, cloprop, cloxyfonac, cyanamide, cyclanilide, cycloheximide, cyprosulfamide, daminozide, DCPTA, dicamba-methyl, dichlorflurenol, dichlorflurenol, dichlorflurenol-methyl, dichlorprop, dikegulac, dimexano, endothal, epocholeone, epocholeone, etacelasil, ethephon, ethephon, ethychlozate, ethylene, fenoprop, fenridazon, flumetralin, fluoridamid, flurenol, flurprimidol, forchlorfenuron, fosamine, fuphenthiourea, furalane, gibberellic acid, glyoxime, glyphosine, heptopargil, heptopargil, hexafluoroacetone trihydrate, holosulf, hymexazol, IAA, IBA, inabenfide, isoprothiolane, isopyrimol, jasmonic acid, karetazan, kinetin, lead arsenate, maleic hydrazide, MCPB, mefluidide, mepiquat, merphos, methasulfocarb, metoxuron, N-(2-ethyl-2H-pyrazol-3-yl)-N′-phenylurea, N-m-Tolylphthalamic acid, N-pyrrolidinosuccinamic acid, naphthaleneacetamide, naphthoxyacetic acids, n-decanol, N-phenylphthalamic acid, nonanoic acid, paclobutrazol, paclobutrazol, pentachlorophenol, piproctanyl, potassium naphthenate, prohexadione-calcium, prohydrojasmon, propham, propyl 3-tert-butylphenoxyacetate, prosuler, pydanon, pyripropanol, sintofen, sodium (Z)-3-chloroacrylate, sodium naphthenate, tecnazene, tetcyclacis, thidiazuron, tiaojiean, triacontanol, triapenthenol, tribufos, trinexapac, trinexapac-ethyl, uniconazole, zeatin, α-naphthaleneacetic acid;
Rodenticides for example, 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyanide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyanide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyanide (444), sodium fluoroacetate (735), strychnine (745), thallium sulfate [CCN], warfarin (851), zinc phosphide (640);
Safeners, for example cloquintocet-mexyl, cloquintocet acid and salts thereof, fenchlorazole-ethyl, fenchlorazole acid and salts thereof, mefenpyr-diethyl, mefenpyr diacid, isoxadifen-ethyl, isoxadifen acid, furilazole, furilazole R isomer, benoxacor, dichlormid, AD-67, oxabetrinil, cyometrinil, cyometrinil Z-isomer, fenclorim, cyprosulfamide, naphthalic anhydride, flurazole, N-(2-methoxybenzoyl)-4-[(methylaminocarbonyl)amino]benzenesulfonamide, CL 304,415, dicyclonon, fluxofenim, DKA-24, R-29148 and PPG-1292;
and synergists for example 2-(2-butoxyethoxyl)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), 5421 (development code) (724), sesamex (1393), sesasmolin (1394), sulfoxide (1406).
In one embodiment, there is provided a composition comprising (A) a compound of formula (I), and
(B) at least one compound selected from the group consisting of:
(B1) a strobilurin fungicide (such as azoxystrobin, pyraclostrobin, fluoxastrobin, trifloxystrobin);
(B2) a demethylation inhibitor fungicide (such as difenoconazole, propiconazole, tebuconazole, cyproconazole, thiabendazole, ipconazole, prothioconazole, triadimenol, imazalil);
(B3) a morpholine fungicide (such as fenpropipmorph);
(B4) an anilinopyrimidine fungicide (such as cyprodinil);
(B5) a carboxamide fungicide (such as sedaxane, boscalid, isopyrazam, fluxapyroxad, penflufen, penthiopyrad, bixafen);
(B6) a dicarboximide fungicide (such as captan);
(B7) a dithiocarbamate fungicide (such as dimethyl dithiocarbamates (DMDCs), ethylene bis dithiocarbamates (EBDCs) including ferbam, thiram, ziram);
(B8) a benzene fungicide (such as Pentachloronitrobenzene (PCNB), terraclor);
(B9) a carboxylic acid amide fungicide (such as mandipropamid);
(B10) another fungicide (such as mefenoxam, metalaxyl, fludioxonil);
(B11) a pyrethroid insecticide (such as lambda cyhalothrin, tefluthrin);
(B12) an organophosphate insecticide (such as profenofos);
(B13) a carbamate insecticide (such as aldicarb, pirimicarb);
(B14) a macrolide insecticide (such as abamectin, emamectin benzoate, spinosad);
(B15) a neonicotinoid insecticide (such as thiamethoxam, clothianidin, imidacloprid);
(B16) a diamide insecticide (such as chlorantraniliprole, cyantraniliprole);
(B17) another insecticide (such as sulfoxaflor);
(B18) a phenylpyrazole (such as fipronil);
(B19) a cyclodiene organochlorine (such as chlordane);
(B20) a tetronic or tetramic acid derivative (such as spirotetramat);
(B21) a plant growth regulator (such as jasmonic acid, trinexapac-ethyl, brassinolide, ethephon); and
(B22) a plant activator (such as acibenzolar-S-methyl).

In one embodiment, component (B) is an insecticide. Preferably when component (B) is an insecticide, it is selected from the list consisting of: thiamethoxam, tefluthrin, cyantraniliprole, abamectin, cis-jasmone, lambda cyhalothrin, chlorantraniliprole, clothianidin, imidacloprid, spinosad and sulfoxaflor. More preferably, when component (B) is an insecticide is it selected from the group consisting of thiamethoxam, tefluthrin, cyantraniliprole, abamectin, chlorantraniliprole, clothianidin, imidacloprid, and sulfoxaflor. More preferably when component (B) is an insecticide is it selected from the group consisting of thiamethoxam, tefluthrin, cyantraniliprole, and abamectin.

In one embodiment, component (B) is a fungicide. Preferably when component (B) is a fungicide, it is selected from the list consisting of: sedaxane, azoxystrobin, mefenoxam, fludioxonil, difenoconazole, boscalid, pyraclostrobin, captan, propiconazole, thiram, tebuconazole, cyproconazole, fluoxastrobin, thiabendazole, ipconazole, metalaxyl, penflufen, trifloxystrobin, prothioconazole, and trifloxystrobin. More preferably, component (B) is selected from the list consisting of sedaxane, azoxystrobin, mefenoxam, fludioxonil, and difenoconazole.

In one embodiment, component (B) is a plant growth regulator. Preferably when component (B) is a plant growth regulator, it is selected from the list consisting of: mepiquat, chlormequat, trinexapac-ethyl, prohexadione-calcium, ethephon, 1-methylcyclopropene, flurprimidol, brassinolide, and paclobutrazol. More preferably, component (B) is selected from the list consisting of trinexapac-ethyl, prohexadione-calcium, paclobutrazol, flurprimidol, brassinolide, mepiquat and chlormequat.

In one embodiment, component (B) is selected from the group consisting of thiamethoxam, tefluthrin, cyantraniliprole, abamectin, cis-jasmone, lambda cyhalothrin, chlorantraniliprole, clothianidin, imidacloprid, sulfoxaflor, sedaxane, azoxystrobin, mefenoxam, fludioxonil, difenoconazole, boscalid, pyraclostrobin, captan, propiconazole, thiram, tebuconazole, cyproconazole, fluoxastrobin, thiabendazole, ipconazole, metalaxyl, penflufen, trifloxystrobin, prothioconazole, trifloxystrobin, mepiquat, chlormequat, trinexapac-ethyl, prohexadione-calcium, ethephon, 1-methylcyclopropene, flurprimidol, brassinolide, and paclobutrazol.

The composition may comprise more than one compound from component (B), thus forming a mixture comprising three or more active ingredients.

In preferred compounds of formula (I), R₂, R₃, R₄ and R₅ are H. Such compounds are hereinafter referred to as formula (Ia).

In preferred compounds of formula (I), R₁ is a C₁-C₄ alkyl. Such compounds are hereinafter referred to as formula (Ib).

In preferred compounds of formula (I), R₆ is a substituted aryl of formula —(CH₂)ₚ aryl, substituted with one or more of halide, —OH, —NO₂ or SO₂R′, where p is an integer of 0 to 4. Such compounds are hereinafter referred to as formula (Ic).

In preferred compounds of formula (I), R₆ has the formula:

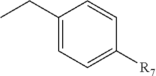

wherein R₇ is —OH, —NO₂, —SO₂R′ or halide. Such compounds are hereinafter referred to as formula (1d).

Especially preferred is the compound of formula (II), also referred to herein as D2:

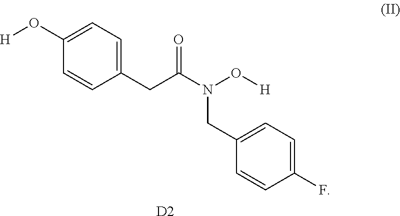 [SMILES: O=C(Cc1ccc(O)cc1)N(O)Cc1ccc(F)cc1 ; "D2"]

Also especially preferred is the compound of formula (III), also referred to herein as D4:

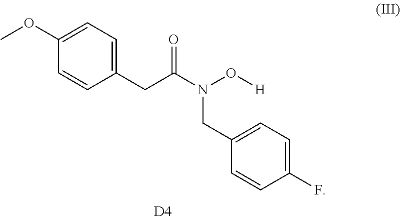 [SMILES: COc1ccc(CC(=O)N(O)Cc2ccc(F)cc2)cc1 ; "D4"]

In particular, the following mixtures may be mentioned:
formula (Ia)+thiamethoxam, formula (Ia)+tefluthrin, formula (Ia)+cyantraniliprole, formula (Ia)+abamectin, formula (Ia)+cis-jasmone, formula (Ia)+lambda cyhalothrin, formula (Ia)+chlorantraniliprole, formula (Ia)+clothianidin, formula (Ia)+imidacloprid, formula (Ia)+sulfoxaflor, formula (Ia)+sedaxane, formula (Ia)+azoxystrobin, formula (Ia)+mefenoxam, formula (Ia)+fludioxonil, formula (Ia)+difenoconazole, formula (Ia)+boscalid, formula (Ia)+pyraclostrobin, formula (Ia)+captan, formula (Ia)+propiconazole, formula (Ia)+thiram, formula (Ia)+tebuconazole, formula (Ia)+cyproconazole, formula (Ia)+fluoxastrobin, formula (Ia)+thiabendazole, formula (Ia)+ipconazole, formula (Ia)+metalaxyl, formula (Ia)+penflufen, formula (Ia)+trifloxystrobin, formula (Ia)+prothioconazole, formula (Ia)+trifloxystrobin, formula (Ia)+mepiquat, formula (Ia)+chlormequat, formula (Ia)+trinexapac-ethyl, formula (Ia)+prohexadione-calcium, formula (Ia)+ethephon, formula (Ia)+1-methylcyclopropene, formula (Ia)+flurprimidol, formula (Ia)+brassinolide, and formula (Ia)+paclobutrazol;
formula (Ib)+thiamethoxam, formula (Ib)+tefluthrin, formula (Ib)+cyantraniliprole, formula (Ib)+abamectin, formula (Ib)+cis-jasmone, formula (Ib)+lambda cyhalothrin, formula (Ib)+chlorantraniliprole, formula (Ib)+clothianidin, formula (Ib)+imidacloprid, formula (Ib)+sulfoxaflor, formula (Ib)+sedaxane, formula (Ib)+azoxystrobin, formula (Ib)+mefenoxam, formula (Ib)+fludioxonil, formula (Ib)+difenoconazole, formula (Ib)+boscalid, formula (Ib)+pyraclostrobin, formula (Ib)+captan, formula (Ib)+propiconazole, formula (Ib)+thiram, formula (Ib)+tebuconazole, formula (Ib)+cyproconazole, formula (Ib)+fluoxastrobin, formula (Ib)+thiabendazole, formula (Ib)+ipconazole, formula (Ib)+metalaxyl, formula (Ib)+penflufen, formula (Ib)+trifloxystrobin, formula (Ib)+prothioconazole, formula (Ib)+trifloxystrobin, formula (Ib)+mepiquat, formula (Ib)+chlormequat, formula (Ib)+trinexapac-ethyl, formula (Ib)+prohexadione-calcium, formula (Ib)+ethephon, formula (Ib)+1-methylcyclopropene, formula (Ib)+flurprimidol, formula (Ib)+brassinolide, and formula (Ib)+paclobutrazol;
formula (Ic)+thiamethoxam, formula (Ic)+tefluthrin, formula (Ic)+cyantraniliprole, formula (Ic)+abamectin, formula (Ic)+cis-jasmone, formula (Ic)+lambda cyhalothrin, formula (Ic)+chlorantraniliprole, formula (Ic)+clothianidin, formula (Ic)+imidacloprid, formula (Ic)+sulfoxaflor, formula (Ic)+sedaxane, formula (Ic)+azoxystrobin, formula (Ic)+mefenoxam, formula (Ic)+fludioxonil, formula (Ic)+difenoconazole, formula (Ic)+boscalid, formula (Ic)+pyraclostrobin, formula (Ic)+captan, formula (Ic)+propiconazole, formula (Ic)+thiram, formula (Ic)+tebuconazole, formula (Ic)+cyproconazole, formula (Ic)+fluoxastrobin, formula (Ic)+thiabendazole, formula (Ic)+ipconazole, formula (Ic)+metalaxyl, formula (Ic)+penflufen, formula (Ic)+trifloxystrobin, formula (Ic)+prothioconazole, formula (Ic)+trifloxystrobin, formula (Ic)+mepiquat, formula (Ic)+chlormequat, formula (Ic)+trinexapac-ethyl, formula (Ic)+prohexadione-calcium, formula (Ic)+ethephon, formula (Ic)+1-methylcyclopropene, formula (Ic)+flurprimidol, formula (Ic)+brassinolide, and formula (Ic)+paclobutrazol;
formula (Id)+thiamethoxam, formula (Id)+tefluthrin, formula (Id)+cyantraniliprole, formula (Id)+abamectin, formula (Id)+cis-jasmone, formula (Id)+lambda cyhalothrin, formula (Id)+chlorantraniliprole, formula (Id)+clothianidin, formula (Id)+imidacloprid, formula (Id)+sulfoxaflor, formula (Id)+sedaxane, formula (Id)+azoxystrobin, formula (Id)+mefenoxam, formula (Id)+fludioxonil, formula (Id)+difenoconazole, formula (Id)+boscalid, formula (Id)+pyraclostrobin, formula (Id)+captan, formula (Id)+propiconazole, formula (Id)+thiram, formula (Id)+tebuconazole, formula (Id)+cyproconazole, formula (Id)+fluoxastrobin, formula (Id)+thiabendazole, formula (Id)+ipconazole, formula (Id)+metalaxyl, formula (Id)+penflufen, formula (Id)+trifloxystrobin, formula (Id)+prothioconazole, formula (Id)+trifloxystrobin, formula (Id)+mepiquat, formula (Id)+chlormequat, formula (Id)+trinexapac-ethyl, formula (Id)+prohexadione-calcium, formula (Id)+ethephon, formula (Id)+1-methylcyclopropene, formula (Id)+flurprimidol, formula (Id)+brassinolide, and formula (Id)+paclobutrazol;
formula (II)+thiamethoxam, formula (II)+tefluthrin, formula (II)+cyantraniliprole, formula (II)+abamectin, formula (II)+cis-jasmone, formula (II)+lambda cyhalothrin, formula (II)+chlorantraniliprole, formula (II)+clothianidin, formula (II)+imidacloprid, formula (II)+sulfoxaflor, formula (II)+sedaxane, formula (II)+azoxystrobin, formula (II)+mefenoxam, formula (II)+fludioxonil, formula (II)+difenoconazole, formula (II)+boscalid, formula (II)+pyraclostrobin, formula (II)+captan, formula (II)+propiconazole, formula (II)+thiram, formula (II)+tebuconazole, formula (II)+cyproconazole, formula (II)+fluoxastrobin, formula (II)+thiabendazole, formula (II)+ipconazole, formula (II)+metalaxyl, formula (II)+penflufen, formula (II)+trifloxystrobin, formula (II)+prothioconazole, formula (II)+trifloxystrobin, formula (II)+mepiquat, formula (II)+chlormequat, formula (II)+trinexapac-ethyl, formula (II)+prohexadione-calcium, formula (II)+ethephon, formula (II)+1-methylcyclopropene, formula (II)+flurprimidol, formula (II)+brassinolide, and formula (II)+paclobutrazol;
formula (III)+thiamethoxam, formula (III)+tefluthrin, formula (III)+cyantraniliprole, formula (III)+abamectin, formula (III)+cis-jasmone, formula (III)+lambda cyhalothrin, formula (III)+chlorantraniliprole, formula (III)+clothianidin, formula (III)+imidacloprid, formula (III)+sulfoxaflor, formula (III)+sedaxane, formula (III)+azoxystrobin, formula (III)+mefenoxam, formula (III)+fludioxonil, formula (III)+difenoconazole, formula (III)+boscalid, formula (III)+pyraclostrobin, formula (III)+captan, formula (II)+propiconazole, formula (III)+thiram, formula (III)+tebuconazole, formula (III)+cyproconazole, formula (III)+fluoxastrobin, formula (III)+thiabendazole, formula (III)+ipconazole, formula (III)+metalaxyl, formula (III)+penflufen, formula (III)+trifloxystrobin, formula (III)+prothioconazole, formula (III)+trifloxystrobin, formula (III)+mepiquat, formula (III)+chlormequat, formula (III)+trinexapac-ethyl, formula (III)+prohexadione-calcium, formula (III)+ethephon, formula (III)+1-methylcyclopropene, formula (III)+flurprimidol, formula (III)+brassinolide, and formula (III)+paclobutrazol.

In one aspect of the present invention, the compound of formula (I) is applied in the form of a composition, further comprising an agriculturally acceptable carrier.

The compounds of formula (I) are generally applied as compositions such as emulsifiable concentrates, suspension concentrates, directly sprayable or dilutable solutions, spreadable pastes, dilute emulsions, soluble powders, dispersible powders, wettable powders, dusts, granules or encapsulations in polymeric substances, which comprise at least one of the active ingredients according to the invention and which are to be selected to suit the intended aims and the prevailing circumstances.

The compositions of the present invention optionally include one or more agriculturally acceptable carriers, auxiliaries, or formulation adjuvants (component (C)), for example solvents or solid carriers, or such as surface-active compounds (surfactants).

Examples of suitable solvents are: unhydrogenated or partially hydrogenated aromatic hydrocarbons, preferably the fractions C8 to C12 of alkylbenzenes, such as xylene mixtures, alkylated naphthalenes or tetrahydronaphthalene, aliphatic or cycloaliphatic hydrocarbons, such as paraffins or cyclohexane, alcohols such as ethanol, propanol or butanol, glycols and their ethers and esters such as propylene glycol, dipropylene glycol ether, ethylene glycol or ethylene glycol monomethyl ether or ethylene glycol monoethyl ether, ketones, such as cyclohexanone, isophorone or diacetone alcohol, strongly polar solvents, such as N-methylpyrrolid-2-one, dimethyl sulfoxide or N,N-dimethylformamide, water, unepoxidized or epoxidized vegetable oils, such as unexpodized or epoxidized rapeseed, castor, coconut or soya oil, and silicone oils.

Solid carriers which are used for example for dusts and dispersible powders are, as a rule, ground natural minerals such as calcite, talc, kaolin, montmorillonite or attapulgite. To improve the physical properties, it is also possible to add highly disperse silicas or highly disperse absorbtive polymers. Suitable particulate adsorptive carriers for granules are porous types, such as pumice, brick grit, sepiolite or bentonite, and suitable non-sorptive carrier materials are calcite or sand. In addition, a large number of granulated materials of inorganic or organic nature can be used, in particular dolomite or comminuted plant residues.

Suitable surface-active compounds are, depending on the type of the active ingredient to be formulated, non-ionic, cationic and/or anionic surfactants or surfactant mixtures which have good emulsifying, dispersing and wetting properties. The surfactants mentioned below are only to be considered as examples; a large number of further surfactants which are conventionally used in the art of formulation and suitable according to the invention are described in the relevant literature.

Suitable non-ionic surfactants are, especially, polyglycol ether derivatives of aliphatic or cycloaliphatic alcohols, of saturated or unsaturated fatty acids or of alkyl phenols which may contain approximately 3 to approximately 30 glycol ether groups and approximately 8 to approximately 20 carbon atoms in the (cyclo)aliphatic hydrocarbon radical or approximately 6 to approximately 18 carbon atoms in the alkyl moiety of the alkyl phenols. Also suitable are water-soluble polyethylene oxide adducts with polypropylene glycol, ethylenediaminopo [symbol] lypropylene glycol or alkyl polypropylene glycol having 1 to approximately 10 carbon atoms in the alkyl chain and approximately 20 to approximately 250 ethylene glycol ether groups and approximately 10 to approximately 100 propylene glycol ether groups. Normally, the abovementioned compounds contain 1 to approximately 5 ethylene glycol units per propy [symbol] ene glycol unit. Examples which may be mentioned are nonylphenoxypolyethoxyethanol, castor oil polyglycol ether, polypropylene glycol/polyethylene oxide adducts, tributylpheno [symbol] xypolyethoxyethanol, polyethylene glycol or octylphenoxypolyethoxyethanol. Also suitable are fatty acid esters of polyoxyethylene sorbitan, such as polyoxyethylene sorbitan trioleate.

The cationic surfactants are, especially, quarternary ammonium salts which generally have at least one alkyl radical of approximately 8 to approximately 22 C atoms as substituents and as further substituents (unhalogenated or halogenated) lower alkyl or hydroxyalkyl or benzyl radicals. The salts are preferably in the form of halides, methylsulfates or ethylsulfates. Examples are stearyltrimethylammonium chloride and benzylbis(2-chloroethyl)ethyl [symbol] ammonium bromide.

Examples of suitable anionic surfactants are water-soluble soaps or water-soluble synthetic surface-active compounds. Examples of suitable soaps are the alkali, alkaline earth or (unsubstituted or substituted) ammonium salts of fatty acids having approximately 10 to approximately 22 C atoms, such as the sodium or potassium salts of oleic or stearic acid, or of natural fatty acid mixtures which are obtainable for example from coconut or tall oil; mention must also be made of the fatty acid methyl taurates. However, synthetic surfactants are used more frequently, in particular fatty sulfonates, fatty sulfates, sulfonated benzimidazole derivatives or alkylaryl sulfonates. As a rule, the fatty sulfonates and fatty sulfates are present as alkali, alkaline earth or (substituted or unsubstituted) ammonium salts and they generally have an alkyl radical of approximately 8 to approximately 22 C atoms, alkyl also to be understood as including the alkyl moiety of acyl radicals; examples which may be mentioned are the sodium or calcium salts of lignosulfonic acid, of the dodecylsulfuric ester or of a fatty alcohol sulfate mixture prepared from natural fatty acids. This group also includes the salts of the sulfuric esters and sulfonic acids of fatty alcohol/ethylene oxide adducts. The sulfonated benzimidazole derivatives preferably contain 2 sulfonyl groups and a fatty acid radical of approximately 8 to approximately 22C atoms. Examples of alkylarylsulfonates are the sodium, calcium or triethanolammonium salts of decylbenzenesulfonic acid, of dibutylnaphthalenesulfonic acid or of a naphthalenesulfonic acid/formaldehyde condensate. Also possible are, furthermore, suitable phosphates, such as salts of the phosphoric ester of a p-nonylphenol/(4-14)ethylene oxide adduct, or phospholipids. Further suitable phosphates are tris-esters of phosphoric acid with aliphatic or aromatic alcohols and/or bis-esters of alkyl phosphonic acids with aliphatic or aromatic alcohols, which are a high performance oil-type adjuvant. These tris-esters have been described, for example, in WO0147356, WO0056146, EP-A-0579052 or EP-A-1018299 or are commercially available under their chemical name. Preferred tris-esters of phosphoric acid for use in the new compositions are tris-(2-ethylhexyl) phosphate, tris-n-octyl phosphate and tris-butoxyethyl phosphate, where tris-(2-ethylhexyl) phosphate is most preferred. Suitable bis-ester of alkyl phosphonic acids are bis-(2-ethylhexyl)-(2-ethylhexyl)-phosphonate, bis-(2-ethylhexyl)-(n-octyl)-phosphonate, dibutyl-butyl phosphonate and bis(2-ethylhexyl)-tripropylene-phosphonate, where bis-(2-ethylhexyl)-(n-octyl)-phosphonate is particularly preferred.

The compositions according to the invention can preferably additionally include an additive comprising an oil of vegetable or animal origin, a mineral oil, alkyl esters of such oils or mixtures of such oils and oil derivatives. The amount of oil additive used in the composition according to the invention is generally from 0.01 to 10%, based on the spray mixture. For example, the oil additive can be added to the spray tank in the desired concentration after the spray mixture has been prepared. Preferred oil additives comprise mineral oils or an oil of vegetable origin, for example rapeseed oil such as ADIGOR® and MERO®, olive oil or sunflower oil, emulsified vegetable oil, such as AMIGO® (Rhône-Poulenc Canada Inc.), alkyl esters of oils of vegetable origin, for example the methyl derivatives, or an oil of animal origin, such as fish oil or beef tallow. A preferred additive contains, for example, as active components essentially 80% by weight alkyl esters of fish oils and 15% by weight methylated rapeseed oil, and also 5% by weight of customary emulsifiers and pH modifiers. Especially preferred oil additives comprise alkyl esters of C₈-C₂₂ fatty acids, especially the methyl derivatives of C₁₂-C₁₈ fatty acids, for example the methyl esters of lauric acid, palmitic acid and oleic acid, being important. Those esters are known as methyl laurate (CAS-111-82-0), methyl palmitate (CAS-112-39-0) and methyl oleate (CAS-112-62-9). A preferred fatty acid methyl ester derivative is Emery® 2230 and 2231 (Cognis GmbH). Those and other oil derivatives are also known from the Compendium of Herbicide Adjuvants, 5th Edition, Southern Illinois University, 2000. Also, alkoxylated fatty acids can be used as additives in the inventive compositions as well as polymethylsiloxane based additives, which have been described in WO08/037373.

The application and action of the oil additives can be further improved by combining them with surface-active substances, such as non-ionic, anionic or cationic surfactants. Examples of suitable anionic, non-ionic and cationic surfactants are listed on pages 7 and 8 of WO 97/34485. Preferred surface-active substances are anionic surfactants of the dodecylbenzylsulfonate type, especially the calcium salts thereof, and also non-ionic surfactants of the fatty alcohol ethoxylate type. Special preference is given to ethoxylated C₁₂-C₂₂ fatty alcohols having a degree of ethoxylation of from 5 to 40. Examples of commercially available surfactants are the Genapol types (Clariant AG). Also preferred are silicone surfactants, especially polyalkyl-oxide-modified heptamethyltrisiloxanes, which are commercially available e.g. as Silwet L-77®, and also perfluorinated surfactants. The concentration of surface-active substances in relation to the total additive is generally from 1 to 30% by weight. Examples of oil additives that consist of mixtures of oils or mineral oils or derivatives thereof with surfactants are Edenor ME SU®, Turbocharge® (Syngenta AG, CH) and Actipron® (BP Oil UK Limited, GB).

The said surface-active substances may also be used in the formulations alone, that is to say without oil additives.

Furthermore, the addition of an organic solvent to the oil additive/surfactant mixture can contribute to a further enhancement of action. Suitable solvents are, for example, Solvesso® (ESSO) and Aromatic Solvent® (Exxon Corporation). The concentration of such solvents can be from 10 to 80% by weight of the total weight. Such oil additives, which may be in admixture with solvents, are described, for example, in U.S. Pat. No. 4,834,908. A commercially available oil additive disclosed therein is known by the name MERGE® (BASF Corporation). A further oil additive that is preferred according to the invention is SCORE® (Syngenta Crop Protection Canada.)

In addition to the oil additives listed above, in order to enhance the activity of the compositions according to the invention it is also possible for formulations of alkylpyrrolidones, (e.g. Agrimax®) to be added to the spray mixture. Formulations of synthetic latices, such as, for example, polyacrylamide, polyvinyl compounds or poly-1-p-menthene (e.g. Bond®, Courier® or Emerald®) can also be used. Solutions that contain propionic acid, for example Eurogkem Pen-e-trate®, can also be mixed into the spray mixture as activity-enhancing agents.

As a rule, the compositions comprise from 0.1 to 99%, especially from 0.1 to 95%, of active ingredient of the compound of formula (I). The compositions generally comprise from 1 to 99.9%, especially from 5 to 99.9%, of at least one solid or liquid adjuvant, it being possible as a rule for 0 to 25%, especially 0.1 to 20%, of the composition to be surfactants (% in each case meaning percent by weight). Whereas concentrated compositions tend to be preferred for commercial goods, the end consumer as a rule uses dilute compositions which have substantially lower concentrations of active ingredient.

The compound of formula (I) is applied to the plant, plant locus or plant propagation material at a rate from 0.1 to 200 g ai/ha, suitably from 0.5 to 100 g ai/ha, preferably from 1 to 100 g ai/ha.

The compositions can also comprise further solid or liquid auxiliaries, such as stabilizers, for example unepoxidized or epoxidized vegetable oils (for example epoxidized coconut oil, rapeseed oil or soya oil), antifoams, for example silicone oil, preservatives, viscosity regulators, binders and/or tackifiers; fertilizers, in particular nitrogen containing fertilizers such as ammonium nitrates and urea as described in WO08/017388, which can enhance the efficacy of the inventive compounds; or other active ingredients for achieving specific effects, for example ammonium or phosphonium salts, in particular halides, (hydrogen)sulphates, nitrates, (hydrogen)carbonates, citrates, tartrates, formiates and acetates, as described in WO07/068427 and WO07/068428, which also can enhance the efficacy of the inventive compounds and which can be used in combination with penetration enhancers such as alkoxalated fatty acids; as well as further active ingredient such as bactericides, fungicides, insecticides, nematocides, plant activators, plant growth regulators, molluscicides or herbicides.

The compositions used according to the invention are prepared in a manner known per se, in the absence of auxiliaries for example by grinding, screening and/or compressing a solid active ingredient and in the presence of at least one auxiliary for example by intimately mixing and/or grinding the active ingredient with the auxiliary (auxiliaries). These processes for the preparation of the compositions and the use of the compounds I for the preparation of these compositions are also a subject of the invention.

The application methods for the compositions, that is the methods of enhancing crops, such as spraying, atomizing, dusting, brushing on, dressing, scattering or pouring—which are to be selected to suit the intended aims of the prevailing circumstances—and the use of the compositions for enhancing crops of the abovementioned type are other subjects of the invention. Typical rates of concentration are between 0.1 and 1000 ppm, preferably between 0.1 and 500 ppm, of active ingredient. The rate of application per hectare is generally 1 to 2000 g of active ingredient per hectare, in particular 10 to 1000 g/ha, preferably 10 to 600 g/ha. In particular, for soil application on field crops, the rates is preferably 10 to 150 g/ha, and for soil application on vegetables, the rates is preferably 5 to 100 g/ha. For foliar application on field crops, preferably 50 to 200 g/ha are used.

One preferred method of application in the field of crop protection is application to the foliage of the plants (foliar application), it being possible to select frequency and rate of application to match the danger of infestation with the pest in question. Alternatively, the active ingredient can reach the plants via the root system (systemic action), by drenching the locus of the plants with a liquid composition or by incorporating the active ingredient in solid form into the locus of the plants, for example into the soil, for example in the form of granules (for soil application, or for surface broadcast). In the case of paddy rice crops, such granules can be metered into the flooded paddy-field.

In particular, the compositions used according to the invention are suitable for the protection of plant propagation material, for example seeds, such as fruit, tubers or kernels, or nursery plants, against pests of the abovementioned type. The propagation material can be treated with the compositions prior to planting, for example seed can be treated prior to sowing.

Alternatively, the compositions can be applied to seed kernels (coating), either by soaking the kernels in a liquid composition or by applying a layer of a solid composition. It is also possible to apply the compositions when the propagation material is planted to the site of application, for example into the seed furrow during drilling. These treatment methods for plant propagation material and the plant propagation material thus treated are further subjects of the invention.

Although it is believed that the present method can be applied to a seed in any physiological state, it is preferred that the seed be in a sufficiently durable state that it incurs no damage during the treatment process. Typically, the seed would be a seed that had been harvested from the field; removed from the plant; and separated from any cob, stalk, outer husk, and surrounding pulp or other non-seed plant material. The seed would preferably also be biologically stable to the extent that the treatment would cause no biological damage to the seed. It is believed that the treatment can be applied to the seed at any time between harvest of the seed and sowing of the seed or during the sowing process (seed directed applications). The seed may also be primed either before or after the treatment.

Even distribution of the compound and adherence thereof to the seeds is desired during propagation material treatment. Treatment could vary from a thin film (dressing) of a formulation containing the compound, for example, a mixture of active ingredient(s), on a plant propagation material, such as a seed, where the original size and/or shape are recognizable to an intermediary state (such as a coating) and then to a thicker film (such as pelleting with many layers of different materials (such as carriers, for example, clays; different formulations, such as of other active ingredients; polymers; and colourants) where the original shape and/or size of the seed is no longer recognisable into the controlled release material or applied between layers of materials, or both.

The seed treatment occurs to an unsown seed, and the term “unsown seed” is meant to include seed at any period between the harvest of the seed and the sowing of the seed in the ground for the purpose of germination and growth of the plant.

Treatment to an unsown seed is not meant to include those practices in which the active ingredient is applied to the soil but would include any application practice that would target the seed during the planting process.

Preferably, the treatment occurs before sowing of the seed so that the sown seed has been pre-treated with the compound. In particular, seed coating or seed pelleting are preferred in the treatment of the compound. As a result of the treatment, the compound is adhered on to the seed and therefore available for pest control.

The treated seeds can be stored, handled, sowed and tilled in the same manner as any other active ingredient treated seed.

Further methods of application of the compositions used according to the invention comprise drip application onto the soil, dipping of parts of plants such as roots bulbs or tubers, drenching the soil, as well as soil injection. These methods are known in the art.

In order to apply a compound of formula (I) for enhancing crops, a compound of formula (I) is usually formulated into a composition which includes, in addition to the compound of formula (I), a suitable inert diluent or carrier and, optionally, a formulation adjuvant in form of a surface active agent (SFA) as described herein or, for example, in EP-B-1062217. SFAs are chemicals which are able to modify the properties of an interface (for example, liquid/solid, liquid/air or liquid/liquid interfaces) by lowering the interfacial tension and thereby leading to changes in other properties (for example dispersion, emulsification and wetting). It is preferred that all compositions (both solid and liquid formulations) comprise, by weight, 0.0001 to 95%, more preferably 1 to 85%, for example 5 to 60%, of a compound of formula (I). The composition is generally used for the control of pests such that a compound of formula (I) is applied at a rate of from 0.1 g to 10 kg per hectare, preferably from 1 g to 6 kg per hectare, more preferably from 1 g to 1 kg per hectare, even more preferably from 25 g to 200 g per hectare, and particularly from 50 g to 100 g per hectare.

When used in a seed dressing, a compound of formula (I) is used at a rate of 0.0001 g to 10 g (for example 0.001 g or 0.05 g), preferably 0.005 g to 10 g, more preferably 0.005 g to 4 g, per kilogram of seed.

In another aspect the present invention provides a composition for crop enhancement comprising a crop enhancing amount of a compound of formula (I) and a suitable carrier or diluent therefor.

In a still further aspect the invention provides a method of crop enhancement which comprises treating the pests or the locus of the pests with a crop enhancing amount of a composition comprising a compound of formula (I).

The compositions can be chosen from a number of formulation types, including dustable powders (DP), soluble powders (SP), water soluble granules (SG), water dispersible granules (WG), wettable powders (WP), granules (GR) (slow or fast release), soluble concentrates (SL), oil miscible liquids (OL), ultra low volume liquids (UL), emulsifiable concentrates (EC), dispersible concentrates (DC), emulsions (both oil in water (EW) and water in oil (EO)), micro-emulsions (ME), suspension concentrates (SC), oil-based suspension concentrate (OD), aerosols, fogging/smoke formulations, capsule suspensions (CS) and seed treatment formulations. The formulation type chosen in any instance will depend upon the particular purpose envisaged and the physical, chemical and biological properties of the compound of formula (I).

Dustable powders (DP) may be prepared by mixing a compound of formula (I) with one or more solid diluents (for example natural clays, kaolin, pyrophyllite, bentonite, alumina, montmorillonite, kieselguhr, chalk, diatomaceous earths, calcium phosphates, calcium and magnesium carbonates, sulphur, lime, flours, talc and other organic and inorganic solid carriers) and mechanically grinding the mixture to a fine powder.

Soluble powders (SP) may be prepared by mixing a compound of formula (I) with one or more water-soluble inorganic salts (such as sodium bicarbonate, sodium carbonate or magnesium sulphate) or one or more water-soluble organic solids (such as a polysaccharide) and, optionally, one or more wetting agents, one or more dispersing agents or a mixture of said agents to improve water dispersibility/solubility. The mixture is then ground to a fine powder. Similar compositions may also be granulated to form water soluble granules (SG).

Wettable powders (WP) may be prepared by mixing a compound of formula (I) with one or more solid diluents or carriers, one or more wetting agents and, preferably, one or more dispersing agents and, optionally, one or more suspending agents to facilitate the dispersion in liquids. The mixture is then ground to a fine powder. Similar compositions may also be granulated to form water dispersible granules (WG).

Granules (GR) may be formed either by granulating a mixture of a compound of formula (I) and one or more powdered solid diluents or carriers, or from pre-formed blank granules by absorbing a compound of formula (I) (or a solution thereof, in a suitable agent) in a porous granular material (such as pumice, attapulgite clays, fuller's earth, kieselguhr, diatomaceous earths or ground corn cobs) or by adsorbing a compound of formula (I) (or a solution thereof, in a suitable agent) on to a hard core material (such as sands, silicates, mineral carbonates, sulphates or phosphates) and drying if necessary. Agents which are commonly used to aid absorption or adsorption include solvents (such as aliphatic and aromatic petroleum solvents, alcohols, ethers, ketones and esters) and sticking agents (such as polyvinyl acetates, polyvinyl alcohols, dextrins, sugars and vegetable oils). One or more other additives may also be included in granules (for example an emulsifying agent, wetting agent or dispersing agent).

Dispersible Concentrates (DC) may be prepared by dissolving a compound of formula (I) in water or an organic solvent, such as a ketone, alcohol or glycol ether. These solutions may contain a surface active agent (for example to improve water dilution or prevent crystallisation in a spray tank).

Emulsifiable concentrates (EC) or oil-in-water emulsions (EW) may be prepared by dissolving a compound of formula (I) in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO 100, SOLVESSO 150 and SOLVESSO 200; SOLVESSO is a Registered Trade Mark), ketones (such as cyclohexanone or methylcyclohexanone) and alcohols (such as benzyl alcohol, furfuryl alcohol or butanol),

N-alkylpyrrolidones (such as N-methylpyrrolidone or N-octylpyrrolidone), dimethyl amides of fatty acids (such as C₈-C₁₀ fatty acid dimethylamide) and chlorinated hydrocarbons. An EC product may spontaneously emulsify on addition to water, to produce an emulsion with sufficient stability to allow spray application through appropriate equipment. Preparation of an EW involves obtaining a compound of formula (I) either as a liquid (if it is not a liquid at room temperature, it may be melted at a reasonable temperature, typically below 70° C.) or in solution (by dissolving it in an appropriate solvent) and then emulsifiying the resultant liquid or solution into water containing one or more SFAs, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents which have a low solubility in water.

Microemulsions (ME) may be prepared by mixing water with a blend of one or more solvents with one or more SFAs, to produce spontaneously a thermodynamically stable isotropic liquid formulation. A compound of formula (I) is present initially in either the water or the solvent/SFA blend. Suitable solvents for use in MEs include those hereinbefore described for use in ECs or in EWs. An ME may be either an oil-in-water or a water-in-oil system (which system is present may be determined by conductivity measurements) and may be suitable for mixing water-soluble and oil-soluble pesticides in the same formulation. An ME is suitable for dilution into water, either remaining as a microemulsion or forming a conventional oil-in-water emulsion.

Suspension concentrates (SC) may comprise aqueous or non-aqueous suspensions of finely divided insoluble solid particles of a compound of formula (I). SCs may be prepared by ball or bead milling the solid compound of formula (I) in a suitable medium, optionally with one or more dispersing agents, to produce a fine particle suspension of the compound. One or more wetting agents may be included in the composition and a suspending agent may be included to reduce the rate at which the particles settle. Alternatively, a compound of formula (I) may be dry milled and added to water, containing agents hereinbefore described, to produce the desired end product.

Oil-based suspension concentrate (OD) may be prepared similarly by suspending finely divided insoluble solid particles of a compound of formula (I) in an organic fluid (for example at least one mineral oil or vegetable oil). ODs may further comprise at least one penetration promoter (for example an alcohol ethoxylate or a related compound), at least one non-ionic surfactants and/or at least one anionic surfactant, and optionally at least one additive from the group of emulsifiers, foam-inhibiting agents, preservatives, anti-oxidants, dyestuffs, and/or inert filler materials. An OD is intended and suitable for dilution with water before use to produce a spray solution with sufficient stability to allow spray application through appropriate equipment.

Aerosol formulations comprise a compound of formula (I) and a suitable propellant (for example n-butane). A compound of formula (I) may also be dissolved or dispersed in a suitable medium (for example water or a water miscible liquid, such as n-propanol) to provide compositions for use in non-pressurised, hand-actuated spray pumps.

A compound of formula (I) may be mixed in the dry state with a pyrotechnic mixture to form a composition suitable for generating, in an enclosed space, a smoke containing the compound.

Capsule suspensions (CS) may be prepared in a manner similar to the preparation of EW formulations but with an additional polymerisation stage such that an aqueous dispersion of oil droplets is obtained, in which each oil droplet is encapsulated by a polymeric shell and contains a compound of formula (I) and, optionally, a carrier or diluent therefor. The polymeric shell may be produced by either an interfacial polycondensation reaction or by a coacervation procedure. The compositions may provide for controlled release of the compound of formula (I) and they may be used for seed treatment. A compound of formula (I) may also be formulated in a biodegradable polymeric matrix to provide a slow, controlled release of the compound.

A compound of formula (I) may also be formulated for use as a seed treatment, for example as a powder composition, including a powder for dry seed treatment (DS), a water soluble powder (SS) or a water dispersible powder for slurry treatment (WS), or as a liquid composition, including a flowable concentrate (FS), a solution (LS) or a capsule suspension (CS). The preparations of DS, SS, WS, FS and LS compositions are very similar to those of, respectively, DP, SP, WP, SC, OD and DC compositions described above. Compositions for treating seed may include an agent for assisting the adhesion of the composition to the seed (for example a mineral oil or a film-forming barrier).

A composition used according to the present invention may include one or more additives to improve the biological performance of the composition (for example by improving wetting, retention or distribution on surfaces; resistance to rain on treated surfaces; or uptake or mobility of a compound of formula (I)). Such additives include surface active agents (SFAs), spray additives based on oils, for example certain mineral oils, vegetable oils or natural plant oils (such as soy bean and rape seed oil), and blends of these with other bio-enhancing adjuvants (ingredients which may aid or modify the action of a compound of formula (I)). Increasing the effect of a compound of formula (I) may for example be achieved by adding ammonium and/or phosphonium salts, and/or optionally at least one penetration promoter such as fatty alcohol alkoxylates (for example rape oil methyl ester) or vegetable oil esters.

Wetting agents, dispersing agents and emulsifying agents may be surface active agents (SFAs) of the cationic, anionic, amphoteric or non-ionic type.

Suitable SFAs of the cationic type include quaternary ammonium compounds (for example cetyltrimethyl ammonium bromide), imidazolines and amine salts.

Suitable anionic SFAs include alkali metals salts of fatty acids, salts of aliphatic monoesters of sulphuric acid (for example sodium lauryl sulphate), salts of sulphonated aromatic compounds (for example sodium dodecylbenzenesulphonate, calcium dodecylbenzenesulphonate, butylnaphthalene sulphonate and mixtures of sodium di-isopropyl- and tri-isopropyl-naphthalene sulphonates), ether sulphates, alcohol ether sulphates (for example sodium laureth-3-sulphate), ether carboxylates (for example sodium laureth-3-carboxylate), phosphate esters (products from the reaction between one or more fatty alcohols and phosphoric acid (predominately mono-esters) or phosphorus pentoxide (predominately di-esters), for example the reaction between lauryl alcohol and tetraphosphoric acid; additionally these products may be ethoxylated), sulphosuccinamates, paraffin or olefine sulphonates, taurates and lignosulphonates.

Suitable SFAs of the amphoteric type include betaines, propionates and glycinates.

Suitable SFAs of the non-ionic type include condensation products of alkylene oxides, such as ethylene oxide, propylene oxide, butylene oxide or mixtures thereof, with fatty alcohols (such as oleyl alcohol or cetyl alcohol) or with alkylphenols (such as octylphenol, nonylphenol or octylcresol); partial esters derived from long chain fatty acids or hexitol anhydrides; condensation products of said partial esters with ethylene oxide; block polymers (comprising ethylene oxide and propylene oxide); alkanolamides; simple esters (for example fatty acid polyethylene glycol esters); amine oxides (for example lauryl dimethyl amine oxide); and lecithins.

Suitable suspending agents include hydrophilic colloids (such as polysaccharides, polyvinylpyrrolidone or sodium carboxymethylcellulose) and swelling clays (such as bentonite or attapulgite).

A compound of formula (I) may be applied by any of the known means of applying agricultural compositions. For example, it may be applied, formulated or unformulated, to the locus of the crops, directly to the crops, including to any part of the plant, including the foliage, stems, branches or roots, to the seed before it is planted, or to the media in which plants are growing or are to be planted (such as soil surrounding the roots, the soil generally, paddy water or hydroponic culture systems), directly or it may be sprayed on, dusted on, applied by dipping, applied as a cream or paste formulation, applied as a vapour or applied through distribution or incorporation of a composition (such as a granular composition or a composition packed in a water-soluble bag) in soil or an aqueous environment.

A compound of formula (I) may also be injected into plants or sprayed onto vegetation using electrodynamic spraying techniques or other low volume methods, or applied by land or aerial irrigation systems.

Compositions for use as aqueous preparations (aqueous solutions or dispersions) are generally supplied in the form of a concentrate containing a high proportion of the active ingredient, the concentrate being added to water before use. These concentrates, which may include DCs, SCs, ODs, ECs, EWs, MEs SGs, SPs, WPs, WGs and CSs, are often required to withstand storage for prolonged periods and, after such storage, to be capable of addition to water to form aqueous preparations which remain homogeneous for a sufficient time to enable them to be applied by conventional spray equipment. Such aqueous preparations may contain varying amounts of a compound of formula (I) (for example 0.0001 to 10%, by weight) depending upon the purpose for which they are to be used.

A compound of formula (I) may be used in mixtures with fertilisers (for example nitrogen-, potassium- or phosphorus-containing fertilisers, and more particularly ammonium nitrate and/or urea fertilizers). Suitable formulation types include granules of fertiliser. The mixtures suitably contain up to 25% by weight of the compound of formula (I).

The invention therefore also provides a fertiliser composition comprising a fertiliser and a compound of formula (I).

Plants in which the composition according to the invention can be used include crops such as cereals (for example wheat, barley, rye, oats); beet (for example sugar beet or fodder beet); fruits (for example pomes, stone fruits or soft fruits, such as apples, pears, plums, peaches, almonds, cherries, strawberries, raspberries or blackberries); leguminous plants (for example beans, lentils, peas or soybeans); oil plants (for example rape, mustard, poppy, olives, sunflowers, coconut, castor oil plants, cocoa beans or groundnuts); cucumber plants (for example marrows, cucumbers or melons); fibre plants (for example cotton, flax, hemp or jute); citrus fruit (for example oranges, lemons, grapefruit or mandarins); vegetables (for example spinach, lettuce, asparagus, cabbages, carrots, onions, tomatoes, potatoes, cucurbits or paprika); lauraceae (for example avocados, cinnamon or camphor); maize; rice; tobacco; nuts; coffee; sugar cane; tea; vines; hops; durian; bananas; natural rubber plants; turf or ornamentals (for example flowers, shrubs, broad-leaved trees or evergreens such as conifers). This list does not represent any limitation.

The invention may also be used to regulate the growth, or promote the germination of seeds of non-crop plants, for example to facilitate weed control by synchronizing germination.

Crops are to be understood as also including those crops which have been modified by conventional methods of breeding or by genetic engineering. For example, the invention may be used in conjunction with crops that have been rendered tolerant to herbicides or classes of herbicides (e.g. ALS-, GS-, EPSPS-, PPO-, ACCase- and HPPD-inhibitors). An example of a crop that has been rendered tolerant to imidazolinones, e.g. imazamox, by conventional methods of breeding is Clearfield® summer rape (canola). Examples of crops that have been rendered tolerant to herbicides by genetic engineering methods include e.g. glyphosate- and glufosinate-resistant maize varieties commercially available under the trade names RoundupReady® and LibertyLink®. Methods of rending crop plants tolerant to HPPD-inhibitors are known, for example from WO0246387; for example the crop plant is transgenic in respect of a polynucleotide comprising a DNA sequence which encodes an HPPD-inhibitor resistant HPPD enzyme derived from a bacterium, more particularly from Pseudomonas fluorescens or Shewanella colwelliana, or from a plant, more particularly, derived from a monocot plant or, yet more particularly, from a barley, maize, wheat, rice, Brachiaria, Chenchrus, Lolium, Festuca, Setaria, Eleusine, Sorghum or Avena species.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt 176 maize hybrids of NK® CD (Syngenta Seeds). The Bt toxin is a protein that is formed naturally by Bacillus thuringiensis soil bacteria. Examples of toxins, or transgenic plants able to synthesise such toxins, are described in EP-A-451 878, EP-A-374 753, WO 93/07278, WO 95/34656, WO 03/052073 and EP-A-427 529. Examples of transgenic plants comprising one or more genes that code for an insecticidal resistance and express one or more toxins are KnockOut® (maize), Yield Gard® (maize), NuCOT1N33B® (cotton), Bollgard® (cotton), NewLeaf® (potatoes), NatureGard® and Protexcta®. Plant crops or seed material thereof can be both resistant to herbicides and, at the same time, resistant to insect feeding (“stacked” transgenic events). For example, seed can have the ability to express an insecticidal Cry3 protein while at the same time being tolerant to glyphosate.

Crops are also to be understood to include those which are obtained by conventional methods of breeding or genetic engineering and contain so-called output traits (e.g. improved storage stability, higher nutritional value and improved flavour).

The present invention also extends to plant, plant parts, plant propagation materials, or a plant growing locus treated with a composition as defined above.

### BIOLOGICAL EXAMPLES

### Method Description Liquid Culture Tests in Well Plates for Mixtures

Fusarium culmorum/Liquid Culture (Head Blight)

Conidia of the fungus from cryogenic storage are directly mixed into nutrient broth (PDB potato dextrose broth). After placing a (DMSO) solution of test compound into a microtiter plate (96-well format), the nutrient broth containing the fungal spores is added. The test plates are incubated at 24° C. and the inhibition of growth is determined photometrically 3-4 days after application and percent antifungal activity relative to the untreated check is calculated.

Gaeumannomyces graminis/Liquid Culture (Take-all of Cereals)

Mycelial fragments of the fungus from cryogenic storage were directly mixed into nutrient broth (PDB potato dextrose broth). After placing a (DMSO) solution of test compound into a microtiter plate (96-well format), the nutrient broth containing the fungal spores is added. The test plates are incubated at 24° C. and the inhibition of growth is determined photometrically 4-5 days after application and percent antifungal activity relative to the untreated check is calculated.

Monographella nivalis (Microdochium nivale)/Liquid Culture (Foot Rot Cereals)

Conidia of the fungus from cryogenic storage are directly mixed into nutrient broth (PDB potato dextrose broth). After placing a (DMSO) solution of test compound into a microtiter plate (96-well format), the nutrient broth containing the fungal spores is added. The test plates are incubated at 24° C. and the inhibition of growth is determined photometrically 4-5 days after application and percent antifungal activity relative to the untreated check is calculated.

Pythium ultimum/Liquid Culture (Seedling Damping Off)

Mycelia fragments and oospores of a newly grown liquid culture of the fungus are directly mixed into nutrient broth (PDB potato dextrose broth). After placing a (DMSO) solution of test compound into a microtiter plate (96-well format), the nutrient broth containing the fungal mycelia/spore mixture is added. The test plates are incubated at 24° C. and the inhibition of growth is determined photometrically 2-3 days after application and percent antifungal activity relative to the untreated check is calculated.

Thanatephorus cucumeris (Rhizoctonia solani)/Liquid Culture (Foot Rot, Damping-Off)

Mycelia fragments of a newly grown liquid culture of the fungus are directly mixed into nutrient broth (PDB potato dextrose broth). After placing a (DMSO) solution of the test compounds into a microtiter plate (96-well format), the nutrient broth containing the fungal material is added. The test plates are incubated at 24° C. and the inhibition of growth is determined photometrically 3-4 days after application and percent antifungal activity relative to the untreated check is calculated.

Ustilago nuda/Liquid Culture (Barley Loose Smut)

Conidia of the fungus from cryogenic storage are directly mixed into nutrient broth (PDB potato dextrose broth). After placing a (DMSO) solution of test compound into a microtiter plate (96-well format), the nutrient broth containing the fungal spores is added. The test plates are incubated at 24° C. and the inhibition of growth is determined photometrically 3-4 days after application and percent antifungal activity relative to the untreated check is calculated.

Results Mixture Trials in Liquid Culture Compound D4 & Azoxystrobin with Pythium ultimum in PDB

| | | % efficacy |
|---|---|---|
| Compounds in mg ai/l (ppm) | % efficacy | expected |

| D4 | Azoxystrobin | observed | (Colby) |
|---|---|---|---|
| 2.5000 | | 0.0 | |
| 1.2500 | | 0.0 | |
| 0.6250 | | 0.0 | |
| | 0.1000 | 45.3 | |
| | 0.0500 | 35.6 | |
| | 0.0250 | 14.0 | |
| 2.5000 | 0.1000 | 59.8 | 45.3 |
| 1.2500 | 0.0500 | 50.5 | 35.6 |
| 0.6250 | 0.0250 | 41.6 | 14.0 |

Results Mixture Trials in Liquid Culture Compound D4 & Azoxystrobin with Gaeumannomyces graminis in PDB

| | | % efficacy |
|---|---|---|
| Compounds in mg ai/l (ppm) | % efficacy | expected |

| D4 | Azoxystrobin | observed | (Colby) |
|---|---|---|---|
| 1.2500 | | 0.0 | |
| 0.6250 | | 0.0 | |
| 0.3125 | | 0.0 | |
| 0.1563 | | 0.0 | |
| 0.0781 | | 0.0 | |
| | 0.0031 | 74.8 | |
| | 0.0016 | 67.0 | |
| | 0.0008 | 40.7 | |
| 1.2500 | 0.0031 | 97.6 | 74.8 |
| 0.6250 | 0.0016 | 89.8 | 67.0 |
| 0.3125 | 0.0008 | 66.4 | 40.7 |
| 0.6250 | 0.0031 | 100.0 | 74.8 |
| 0.3125 | 0.0016 | 74.2 | 67.0 |
| 0.1563 | 0.0008 | 57.4 | 40.7 |
| 0.0781 | 0.0008 | 45.4 | 40.7 |
| 0.1563 | 0.0031 | 97.6 | 74.8 |
| 0.0781 | 0.0016 | 74.2 | 67.0 |
| 0.0781 | 0.0031 | 99.4 | 74.8 |

Results Mixture Trials in Liquid Culture Compound D4 & Sedaxane with Thanatephorus cucumeris (Syn. Rhizoctonia solani) in PDB

| | | % efficacy |
|---|---|---|
| Compounds in mg ai/l (ppm) | % efficacy | expected |

| D4 | Sedaxane | observed | (Colby) |
|---|---|---|---|
| 10.0000 | | 4.4 | |
| 5.0000 | | 0.0 | |
| 2.5000 | | 0.0 | |
| 1.2500 | | 0.0 | |
| 0.6250 | | 2.1 | |
| 0.3125 | | 0.0 | |
| 0.1563 | | 0.0 | |
| 0.0781 | | 0.0 | |
| | 0.7500 | 72.2 | |
| | 0.3750 | 72.2 | |
| | 0.1875 | 71.1 | |
| | 0.0938 | 41.1 | |
| | 0.0469 | 0.0 | |
| 10.000 | 0.7500 | 92.2 | 73.4 |
| 5.0000 | 0.3750 | 93.3 | 72.2 |
| 2.5000 | 0.1875 | 90.0 | 71.1 |
| 1.2500 | 0.0938 | 75.5 | 41.1 |
| 0.6250 | 0.0469 | 41.1 | 2.1 |
| 2.5000 | 0.7500 | 100.0 | 72.2 |
| 1.2500 | 0.3750 | 95.6 | 72.2 |
| 0.6250 | 0.1875 | 81.1 | 71.7 |
| 0.3125 | 0.0938 | 73.3 | 41.1 |
| 1.2500 | 0.7500 | 93.3 | 72.2 |
| 0.6250 | 0.3750 | 100.0 | 72.8 |
| 0.3125 | 0.1875 | 91.1 | 71.1 |
| 0.6250 | 0.7500 | 95.6 | 72.8 |
| 0.3125 | 0.3750 | 84.4 | 72.2 |
| 0.1563 | 0.1875 | 78.9 | 71.1 |
| 0.0781 | 0.0938 | 62.2 | 41.1 |

Results Mixture Trials in Liquid Culture Compound D4 & Sedaxane with Gaeumannomyces graminis in PDB

| | | % efficacy |
|---|---|---|
| Compounds in mg ai/l (ppm) | % efficacy | expected |

| D4 | Sedaxane | observed | (Colby) |
|---|---|---|---|
| 20.0000 | | 0.0 | |
| 10.0000 | | 0.0 | |
| 5.0000 | | 0.0 | |
| 2.5000 | | 0.0 | |
| 1.2500 | | 0.0 | |
| | 1.5000 | 46.7 | |
| 20.000 | 1.5000 | 76.8 | 46.7 |
| 10.000 | 1.5000 | 64.9 | 46.7 |
| 5.0000 | 1.5000 | 70.5 | 46.7 |
| 1.2500 | 1.5000 | 55.5 | 46.7 |

Results Mixture Trials in Liquid Culture Compound D4 & Sedaxane with Ustilago nuda 1. Sp. Hordei (Syn. Ustilago nuda) in PDB

| | | % efficacy |
|---|---|---|
| Compounds in mg ai/l (ppm) | % efficacy | expected |

| D4 | Sedaxane | observed | (Colby) |
|---|---|---|---|
| 0.1563 | | 3.7 | |
| 0.0781 | | 2.5 | |
| 0.0391 | | 8.7 | |
| | 0.0117 | 55.0 | |
| 0.1563 | 0.0117 | 92.0 | 56.6 |
| 0.0781 | 0.0117 | 82.1 | 56.1 |
| 0.0391 | 0.0117 | 73.5 | 58.9 |

Results Mixture Trials in Liquid Culture Compound D4 & Fluxapyroxad with Thanatephorus cucumeris (Syn. Rhizoctonia solani) in PDB

| | | % efficacy |
|---|---|---|
| Compounds in mg ai/l (ppm) | % efficacy | expected |

| D4 | Fluxapyroxad | observed | (Colby) |
|---|---|---|---|
| 20.0000 | | 0.0 | |
| 10.0000 | | 9.6 | |
| 5.0000 | | 0.6 | |
| 2.5000 | | 0.0 | |
| 1.2500 | | 5.6 | |
| 0.6250 | | 4.6 | |
| 0.3125 | | 0.0 | |
| | 1.5000 | 67.9 | |
| | 0.7500 | 71.9 | |
| | 0.3750 | 61.8 | |
| | 0.1875 | 29.7 | |
| 20.000 | 1.5000 | 91.0 | 67.9 |
| 10.000 | 0.7500 | 93.0 | 74.6 |
| 10.000 | 1.5000 | 86.9 | 70.9 |
| 5.0000 | 0.7500 | 96.0 | 72.0 |
| 2.5000 | 0.3750 | 89.0 | 61.8 |
| 1.2500 | 0.1875 | 46.8 | 33.6 |
| 5.0000 | 1.5000 | 98.0 | 68.0 |
| 1.2500 | 0.3750 | 77.9 | 64.0 |
| 2.5000 | 1.5000 | 81.9 | 67.9 |
| 1.2500 | 0.7500 | 85.9 | 73.4 |
| 0.6250 | 0.3750 | 85.9 | 63.6 |
| 0.3125 | 0.1875 | 36.7 | 29.7 |
| 1.2500 | 1.5000 | 80.9 | 69.7 |
| 0.6250 | 0.7500 | 83.9 | 73.2 |
| 0.3125 | 0.3750 | 73.9 | 61.8 |

Results Mixture Trials in Liquid Culture Compound D4 & Fluxapyroxad with Monographella nivalis (Syn. Microdochium nivale) in PDB

| | | % efficacy |
|---|---|---|
| Compounds in mg ai/l (ppm) | % efficacy | expected |

| D4 | Fluxapyroxad | observed | (Colby) |
|---|---|---|---|
| 0.6250 | | 0.0 | |
| 0.3125 | | 10.2 | |
| 0.1563 | | 6.7 | |
| | 0.7500 | 65.4 | |
| | 0.3750 | 55.5 | |
| | 0.1875 | 22.2 | |
| 0.3125 | 0.1875 | 40.6 | 30.2 |
| 0.6250 | 0.7500 | 77.4 | 65.4 |
| 0.3125 | 0.3750 | 85.2 | 60.0 |
| 0.1563 | 0.1875 | 64.6 | 27.4 |

Results Mixture Trials in Liquid Culture D4 & Penflufen with Thanatephorus cucumeris (Syn. Rhizoctonia solani) in PDB

| | | % efficacy |
|---|---|---|
| Compounds in mg ai/l (ppm) | % efficacy | expected |

| D4 | Penflufen | observed | (Colby) |
|---|---|---|---|
| 10.0000 | | 0.0 | |
| 5.0000 | | 6.3 | |
| 2.5000 | | 0.0 | |
| 1.2500 | | 15.3 | |
| 0.6250 | | 0.0 | |
| 0.3125 | | 10.8 | |
| 0.1563 | | 0.0 | |
| 0.0781 | | 0.0 | |
| | 0.2500 | 83.3 | |
| | 0.1250 | 64.3 | |
| | 0.0625 | 42.0 | |
| | 0.0313 | 7.5 | |
| | 0.0156 | 20.8 | |
| 10.000 | 0.2500 | 96.7 | 83.3 |
| 5.0000 | 0.1250 | 100.0 | 66.6 |
| 2.5000 | 0.0625 | 96.7 | 42.0 |
| 1.2500 | 0.0313 | 91.1 | 21.6 |
| 0.6250 | 0.0156 | 71.0 | 20.8 |
| 5.0000 | 0.2500 | 100.0 | 84.3 |
| 2.5000 | 0.1250 | 94.4 | 64.3 |
| 1.2500 | 0.0625 | 90.0 | 50.9 |
| 0.6250 | 0.0313 | 72.1 | 7.5 |
| 0.3125 | 0.0156 | 58.7 | 29.4 |
| 0.6250 | 0.0625 | 78.8 | 42.0 |
| 0.3125 | 0.0313 | 77.7 | 17.5 |
| 1.2500 | 0.2500 | 97.8 | 85.8 |
| 0.6250 | 0.1250 | 98.9 | 64.3 |
| 0.3125 | 0.0625 | 75.5 | 48.3 |
| 0.3125 | 0.1250 | 76.6 | 68.2 |
| 0.1563 | 0.0625 | 77.7 | 42.0 |
| 0.0781 | 0.0313 | 64.3 | 7.5 |

Results Mixture Trials in Liquid Culture D4 & Penflufen with Monographella nivalis (Syn. Microdochium nivale) in PDB

| | | % efficacy |
|---|---|---|
| Compounds in mg ai/l (ppm) | % efficacy | expected |

| D4 | Penflufen | observed | (Colby) |
|---|---|---|---|
| 20.0000 | | 1.4 | |
| 10.0000 | | 6.4 | |
| 5.0000 | | 2.1 | |
| 2.5000 | | 2.8 | |
| | 2.0000 | 56.8 | |
| | 1.0000 | 19.4 | |
| 20.0000 | 2.0000 | 64.7 | 57.4 |
| 10.0000 | 2.0000 | 61.1 | 59.6 |
| 5.0000 | 1.0000 | 35.9 | 21.0 |
| 5.0000 | 2.0000 | 63.3 | 57.7 |
| 2.5000 | 1.0000 | 37.4 | 21.6 |

Results Mixture Trials in Liquid Culture D4 & Penflufen with Ustilago nuda 1. Sp. Hordei (Syn. Ustilago nuda) in PDB

| | | % efficacy |
|---|---|---|
| Compounds in mg ai/l (ppm) | % efficacy | expected |

| D4 | Penflufen | observed | (Colby) |
|---|---|---|---|
| 0.1563 | | 0.0 | |
| 0.0781 | | 0.2 | |
| 0.0391 | | 0.0 | |
| | 0.0039 | 23.1 | |
| 0.1563 | 0.0039 | 100.0 | 23.1 |
| 0.0781 | 0.0039 | 97.5 | 23.2 |
| 0.0391 | 0.0039 | 73.9 | 23.1 |

Results Mixture Trials in Liquid Culture D4 & Difenconazole with Thanatephorus cucumeris (Syn. Rhizoctonia solani) in PDB

| | | % efficacy |
|---|---|---|
| Compounds in mg ai/l (ppm) | % efficacy | expected |

| D4 | Difenconazole | observed | (Colby) |
|---|---|---|---|
| 20.0000 | | 0.0 | |
| 10.0000 | | 5.0 | |
| 2.5000 | | 10.2 | |
| | 1.0000 | 0.0 | |
| | 0.5000 | 0.0 | |
| 20.0000 | 0.5000 | 72.9 | 0.0 |
| 20.0000 | 1.0000 | 84.3 | 0.0 |
| 10.0000 | 0.5000 | 65.6 | 5.0 |
| 10.0000 | 1.0000 | 76.0 | 5.0 |
| 2.5000 | 1.0000 | 54.1 | 10.2 |

Results Mixture Trials in Liquid Culture D4 & Difenconazole with Gaeumannomyces Graminis in PDB

| | | % efficacy |
|---|---|---|
| Compounds in mg ai/l (ppm) | % efficacy | expected |

| D4 | Difenconazole | observed | (Colby) |
|---|---|---|---|
| 0.000000 | | 5.3 | |
| 20.0000 | | 0.0 | |
| 10.0000 | | 0.0 | |
| 5.0000 | | 0.0 | |
| | 2.0000 | 39.0 | |
| | 1.0000 | 10.6 | |
| | 0.5000 | 0.0 | |
| 20.0000 | 1.0000 | 53.2 | 10.6 |
| 10.0000 | 0.5000 | 32.5 | 0.0 |
| 20.0000 | 2.0000 | 85.2 | 39.0 |
| 10.0000 | 2.0000 | 45.0 | 39.0 |
| 5.0000 | 1.0000 | 34.3 | 10.6 |
| 5.0000 | 2.0000 | 47.9 | 39.0 |

Results Mixture Trials in Liquid Culture D4 & Difenconazole with Ustilago nuda 1. Sp. Hordei (Syn. Ustilago nuda) in PDB

| | | % efficacy |
|---|---|---|
| Compounds in mg ai/l (ppm) | % efficacy | expected |

| D4 | Difenconazole | observed | (Colby) |
|---|---|---|---|
| 20.0000 | | 1.3 | |
| 2.5000 | | 7.0 | |
| 1.2500 | | 0.0 | |
| | 2.0000 | 60.5 | |
| | 1.0000 | 45.9 | |
| | 0.5000 | 30.0 | |
| 20.0000 | 2.0000 | 76.4 | 61.0 |
| 2.5000 | 1.0000 | 58.0 | 49.7 |
| 1.2500 | 0.5000 | 41.4 | 30.0 |

Results Mixture Trials in Liquid Culture D4 & Tebuconazole with Thanatephorus cucumeris (Syn. Rhizoctonia solani) in PDB

| | | % efficacy |
|---|---|---|
| Compounds in mg ai/l (ppm) | % efficacy | expected |

| D4 | Tebuconazole | observed | (Colby) |
|---|---|---|---|
| 20.0000 | | 0.0 | |
| 10.0000 | | 0.5 | |
| 5.0000 | | 12.0 | |
| | 2.0000 | 0.0 | |
| | 1.0000 | 0.0 | |
| 20.0000 | 2.0000 | 82.8 | 0.0 |
| 10.0000 | 1.0000 | 38.8 | 0.5 |
| 10.0000 | 2.0000 | 79.0 | 0.5 |
| 5.0000 | 2.0000 | 55.1 | 12.0 |

Results Mixture Trials in Liquid Culture D4 & Tebuconazole with Gaeumannomyces graminis in PDB

| | | % efficacy |
|---|---|---|
| Compounds in mg ai/l (ppm) | % efficacy | expected |

| D4 | Tebuconazole | observed | (Colby) |
|---|---|---|---|
| 20.0000 | | 0.0 | |
| 10.0000 | | 0.0 | |
| 5.0000 | | 0.0 | |
| 1.2500 | | 0.0 | |
| 0.6250 | | 0.0 | |
| | 2.0000 | 74.0 | |
| | 1.0000 | 61.0 | |
| | 0.5000 | 47.5 | |
| | 0.2500 | 43.5 | |
| 10.0000 | 0.2500 | 52.0 | 43.5 |
| 10.0000 | 0.5000 | 55.4 | 47.5 |
| 20.0000 | 2.0000 | 84.2 | 74.0 |
| 10.0000 | 1.0000 | 65.0 | 61.0 |
| 5.0000 | 0.5000 | 57.1 | 47.5 |
| 1.2500 | 0.5000 | 62.2 | 47.5 |
| 0.6250 | 0.2500 | 55.9 | 43.5 |

Results Mixture Trials in Liquid Culture D4 & Thiabendazole with Fusarium culmorum in PDB

| | | | % efficacy |
|---|---|---|---|
| Compounds in mg ai/l (ppm) | | % efficacy | expected |
| D4 | Thiabendazole | observed | (Colby) |
| 20.0000 | | 0.0 | |
| 10.0000 | | 0.0 | |
| | 6.0000 | 71.7 | |
| | 3.0000 | 45.3 | |
| 20.0000 | 3.0000 | 88.1 | 45.3 |
| 20.0000 | 6.0000 | 90.0 | 71.7 |
| 10.0000 | 3.0000 | 97.7 | 45.3 |
| 10.0000 | 6.0000 | 87.8 | 71.7 |

Results Mixture Trials in Liquid Culture D4 & Fludioxonyl with Thanatephorus cucumeris (Syn. Rhizoctonia solani) in PDB

| | | | % efficacy |
|---|---|---|---|
| Compounds in mg ai/l (ppm) | | % efficacy | expected |
| D4 | Fludioxonyl | observed | (Colby) |
| 20.0000 | | 0.0 | |
| 10.0000 | | 0.0 | |
| 5.0000 | | 10.8 | |
| 2.5000 | | 0.0 | |
| 1.2500 | | 0.0 | |
| | 1.0000 | 86.8 | |
| | 0.5000 | 60.5 | |
| | 0.2500 | 66.5 | |
| | 0.1250 | 13.8 | |
| 20.0000 | 0.5000 | 95.9 | 60.5 |
| 10.0000 | 0.2500 | 81.7 | 66.5 |
| 5.0000 | 0.1250 | 37.1 | 23.1 |
| 20.0000 | 1.0000 | 99.0 | 86.8 |
| 10.0000 | 0.5000 | 87.8 | 60.5 |
| 5.0000 | 0.2500 | 90.9 | 70.1 |
| 10.0000 | 1.0000 | 100.0 | 86.8 |
| 5.0000 | 0.5000 | 78.7 | 64.7 |
| 2.5000 | 0.2500 | 72.6 | 66.5 |
| 5.0000 | 1.0000 | 98.0 | 88.2 |
| 2.5000 | 0.5000 | 92.9 | 60.5 |
| 1.2500 | 0.2500 | 73.6 | 66.5 |
| 2.5000 | 1.0000 | 99.0 | 86.8 |
| 1.2500 | 0.5000 | 94.9 | 60.5 |

Results Mixture Trials in Liquid Culture D4 & Fludioxonyl with Ustilago nuda 1. Sp. Hordei (Syn. Ustilago nuda) in PDB

| | | | % efficacy |
|---|---|---|---|
| Compounds in mg ai/l (ppm) | | % efficacy | expected |
| D4 | Fludioxonyl | observed | (Colby) |
| 1.2500 | | 0.0 | |
| 0.6250 | | 0.0 | |
| 0.3125 | | 0.0 | |
| 0.1563 | | 0.0 | |
| | 0.0313 | 33.1 | |
| 1.2500 | 0.0313 | 76.2 | 33.1 |
| 0.6250 | 0.0313 | 71.5 | 33.1 |
| 0.3125 | 0.0313 | 66.2 | 33.1 |
| 0.1563 | 0.0313 | 51.0 | 33.1 |

Results Mixture Trials in Liquid Culture D4 & Mefenoxam with Pythium ultimum in PDB

| | | | % efficacy |
|---|---|---|---|
| Compounds in mg ai/l (ppm) | | % efficacy | expected |
| D4 | Mefenoxam | observed | (Colby) |
| 2.5000 | | 0.0 | |
| 1.2500 | | 0.0 | |
| 0.6250 | | 0.0 | |
| 0.3125 | | 0.0 | |
| 0.1563 | | 0.0 | |
| 0.0391 | | 0.0 | |
| | 0.1250 | 84.4 | |
| | 0.0625 | 71.3 | |
| | 0.0313 | 70.2 | |
| | 0.0156 | 37.8 | |
| | 0.0078 | 34.1 | |
| 0.6250 | 0.0156 | 57.2 | 37.8 |
| 0.3125 | 0.0078 | 43.8 | 34.1 |
| 2.5000 | 0.1250 | 93.3 | 84.4 |
| 1.2500 | 0.0625 | 76.5 | 71.3 |
| 0.6250 | 0.0313 | 72.1 | 70.2 |
| 0.3125 | 0.0156 | 49.7 | 37.8 |
| 0.1563 | 0.0078 | 43.0 | 34.1 |
| 0.1563 | 0.0156 | 47.1 | 37.8 |
| 0.1563 | 0.0625 | 82.9 | 71.3 |
| 0.0391 | 0.0156 | 42.3 | 37.8 |

1. A composition comprising (A) a compound of formula (I), 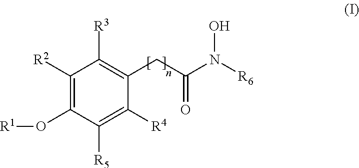
wherein:
R₁ is alkyl or H;
R₂, R₃, R₄ and R₅ are independently selected from the group consisting of H, halide, —NO₂, —SO₂R′, —OH, —Oalkyl where R′ is alkyl or aminoalkyl;
and/or R₁ and R₅ are joined as —O(CH₂)ₘ—, where m is 1, 2, 3 or 4;
R₆ is a substituted or non-substituted alkyl, and/or substituted or non-substituted aryl; and
n is an integer of 1 to 4;
(B) at least one other active ingredient, and optionally (C) one or more formulation adjuvants.

2. A composition according to claim 1, wherein component (B) is at least one compound selected from the group consisting of:
(B1) a strobilurin fungicide;
(B2) a demethylation inhibitor fungicide;
(B3) a morpholine fungicide;
(B4) an anilinopyrimidine fungicide;
(B5) a carboxamide fungicide;
(B6) a dicarboximide fungicide;
(B7) a dithiocarbamate fungicide;
(B8) a benzene fungicide;
(B9) a carboxylic acid amide fungicide;
(B10) another fungicide;
(B11) a pyrethroid insecticide;
(B12) an organophosphate insecticide;
(B13) a carbamate insecticide;
(B14) a macrolide insecticide;
(B15) a neonicotinoid insecticide;
(B16) a diamide insecticide;
(B17) another insecticide;
(B18) a phenylpyrazole;
(B19) a cyclodiene organochlorine;
(B20) a tetronic or tetramic acid derivative;
(B21) a plant growth regulator; and
(B22) a plant activator.

3. A composition according to claim 2, wherein component (B) is an insecticide selected from the list consisting of thiamethoxam, tefluthrin, cyantraniliprole, abamectin, cis-jasmone, lambda cyhalothrin, chlorantraniliprole, clothianidin, imidacloprid, spinosad and sulfoxaflor.

4. A composition according to claim 2, wherein component (B) is a fungicide selected from the list consisting of sedaxane, azoxystrobin, mefenoxam, fludioxonil, difenoconazole, boscalid, pyraclostrobin, captan, propiconazole, thiram, tebuconazole, cyproconazole, fluoxastrobin, thiabendazole, ipconazole, metalaxyl, penflufen, trifloxystrobin, prothioconazole, and trifloxystrobin.

5. A composition according to claim 2, wherein component (B) is a plant growth regulator selected from the list consisting of mepiquat, chlormequat, trinexapac-ethyl, prohexadione-calcium, ethephon, 1-methylcyclopropene, flurprimidol, brassinolide, and paclobutrazol.

6. A composition according to claim 2, wherein component (B) is selected from the list consisting of thiamethoxam, tefluthrin, cyantraniliprole, abamectin, chlorantraniliprole, clothianidin, imidacloprid, sulfoxaflor, sedaxane, azoxystrobin, mefenoxam, fludioxonil, and difenoconazole, acibenzolar-S-methyl, trinexapac-ethyl, prohexadione-calcium, paclobutrazol, flurprimidol, mepiquat and chlormequat.

7. A composition according to claim 2, further comprising at least one additional compound of component (B).

8. A composition according to claim 1, wherein in formula (I) R₆ is a substituted aryl of formula —(CH₂)ₚ aryl, substituted with one or more of halide, —OH, —NO₂ or SO₂R′, where p is an integer of 0 to 4.

9. A composition according to claim 1, wherein in formula (I) R₆ has the formula 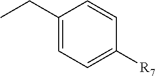
wherein R₇ is —OH, —NO₂, —SO₂R′ or halide.

10. A composition according to claim 9, wherein component (A) is the compound of formula (II):

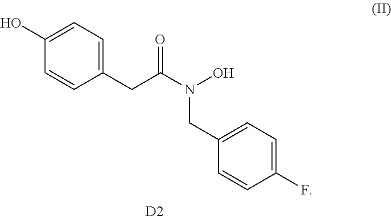 [SMILES: O=C(Cc1ccc(O)cc1)N(O)Cc1ccc(F)cc1 ; "D2"]

11. A composition according to claim 9, wherein component (A) is the compound of formula (III):

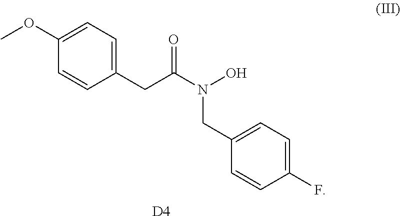 [SMILES: COc1ccc(CC(=O)N(O)Cc2ccc(F)cc2)cc1 ; "D4"]

12. A plant, plant part, plant propagation materials, or plant growing locus treated with a composition according to claim 1.
